(19) United States
(12) Patent Application Publication
(10) Pub. No.: US 2019/0087542 A1
(43) Pub. Date: Mar. 21, 2019

(54) SYSTEM AND METHOD FOR CROSS-REGION PATIENT DATA MANAGEMENT AND COMMUNICATION

(71) Applicant: EasyMarkit Software Inc., Vancouver (CA)

(72) Inventor: Owen Ingraham, Vancouver (CA)

(73) Assignee: EasyMarkit Software Inc., Vancouver (CA)

(21) Appl. No.: 15/711,096

(22) Filed: Sep. 21, 2017

(51) Int. Cl. G06F 19/00; G06Q 50/24; G06F 21/62

(52) U.S. Cl. CPC G06F 19/322; G06F 21/6245; G06Q 50/24

(57) ABSTRACT

A multiple zone and global-based architecture able to address security and privacy concerns and requirements that arise when managing patient data, communicating with patients, and engagement with patients is described. A primary motivation for the various embodiments centers around the security, privacy, and protection of health and healthcare-related data that can be linked or identifiable with a specific patient. Governments agencies at different levels in a growing number of countries are proposing guidelines and enacting regulations and laws that specifically address security, protection, and privacy of health data relating to individuals. The zone-based system of the present invention facilitates abiding by the myriad data privacy regulations and allows for customizing rules to meet regional standards as they change.

### BACKGROUND OF THE INVENTION

### 1. Field of the Invention

The present invention relates to office and patient management software. More specifically, it relates to software and systems for managing and storing patient data to make office operations and patient communications more efficient and productive and to provide a source for office and patient data analytics.

### 2. Description of the Related Art

Presently, dental, medical, and veterinary offices and patient management software are lacking in certain tools and capabilities. One major area is in the area of ensuring that patient data is secured and kept private and protected according to the current standards of the region where the patients and offices are located. Administrators and professionals running these offices are not able to easily change the data security rules that protect their patient data to ensure that the rules abide by local regulations and laws, whether city, state, country, and the like. Nearly all software packages or solutions, if not all, are unable to offer customization of local resources to meet increasingly complex and enforced health and patient data regulations and laws.

Current patient management tools also lack features that make it easier to manage patient communications and appointments, collect and analyze patient data, and measure office performance. Office management software has limited capabilities with respect to managing patient appointments, collecting and mining patient data, abiding by regional patient privacy regulations, among other features. Current software also falls short with respect to communicating with a variety of different databases which presently store patient data.

What is needed is a software tool to address these data security and patient communication deficiencies. A software solution and architecture that enables region-specific and customizable data security management, as well as transmitting personalized, automated notifications from an office via text, email, or voice messaging. The software should also enable referrals, reviews, and quality improvement surveys which engage current patients and help bring in new ones. In addition, it would be beneficial if these features and others facilitated building a brand for the office and practice.

### BRIEF DESCRIPTION OF THE DRAWINGS

References are made to the accompanying drawings, which form a part of the description and in which are shown, by way of illustration, specific embodiments of the present invention:

FIG. 1 is an overview block diagram showing the primary entities of the present invention;

FIG. 2 is a block diagram showing a network configuration and primary entities in accordance with one embodiment;

FIG. 3 is a block diagram showing additional components of a patient management service provider in accordance with one embodiment;

FIG. 4 is a flow diagram of process of communication and engagement between an office and a patient in accordance with one embodiment; and

FIG. 5 is a diagram of a computer system in accordance with one embodiment.

### SUMMARY OF THE INVENTION

In one aspect of the present invention, a system for improving security and protection of patient data and management of this data at a client site, such as a dentist, doctor, or veterinary office, and enabling highly efficient and effective communication between the client and its patients are described. The system is a zone-based system where one or more zones correspond to a specific geographic region having a specific set of patient health data rules, regulations, and guidelines. A rule set for implementing these health data privacy regulations for a specific region can be customized without affecting zones in other regions.

In addition, the system provides tools that enable the client to heighten engagement with patients as well as gather and analyze patient data for deep analytics. In one embodiment, a method of managing patient data and communicating with a patient is described. A service-provider application is installed on a client server wherein the application operates with client (or patient) data in the data's existing database format. The application connects with a service-provider API and examines the client data to identify patient data that was recently modified. The recently modified data only is converted from the pre-existing format to a service-provider format; the non-modified data stays in the original database format. The converted modified data is stored in a service-provider application storage area. A zone application detects that a patient record does not exist in the application storage area and adds the patient record to the storage.

A body of logic and rules is then applied to the recently modified data in the service-provider format, thereby determining how the client can most effectively and efficiently communicate with its patients. In one embodiment, a service-provider API has a sub-worker process component which receives the recently modified data.

In another aspect of the invention, a system for managing patient data and implementing patient data security parameters is described. The system includes a number of components, modules, and servers. A client-side application is installed at a client site, the application having an API and a storage area. Multiple zones servers each one having a zone database, a zone API, and an administration web services module, and a zone process. A zone server is assigned to a specific region (e.g., country, state, province, city, etc.) and a region can have multiple zone servers. A global manager server has a global API, a manager system, and a global database. In one embodiment, a first subset of zone servers services a first region and a second subset of zone servers services a second region. Multiple regions are serviced by the global manager server. In one embodiment, the client-side application is in communication with the zone API and the global API.

### DETAILED DESCRIPTION OF THE INVENTION

Example embodiments of an office and patient management software system are described. These examples and embodiments are provided solely to add context and aid in the understanding of the invention. Thus, it will be apparent to one skilled in the art that the present invention may be practiced without some or all of the specific details described herein. In other instances, well-known concepts have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

Methods and systems for a multiple zone and global based architecture able to address security and privacy concerns and requirements that arise when managing patient data, treatment communications to patients, and engagement with patients are described in various figures. A primary motivation for the various embodiments of the present invention revolves around the security, privacy, and protection of health and healthcare-related data that can be linked or identifiable with a specific patient.

Governments and regulatory agencies at different levels in a growing number of countries are proposing guidelines and enacting regulations and laws that specifically address security, protection, and privacy of health data relating to individuals. The definition of health data and health-related data shifts, can be broad, and vary region to region. For example, in the United States, under a schema referred to as Protected Health Information (“PHI”), health data includes information about health status, provisions of healthcare, and payment of healthcare that is “linked” or identifiable to a specific individual. To aide in understanding embodiments of the present invention, a brief explanation of how PHI originated would be helpful.

In the United States, PHI is information protected by the “Standards for Privacy of Individual Identifiable Health Information,” sometimes referred to as the “Privacy Rule.” The Privacy Rule was created by the Department of Health and Human Services to implement or carry out the now wide-spread Health Insurance Portability and Accountability Act of 1996 or “HIPAA”. This Act states that healthcare entities “take all reasonable precautions” to ensure that individual health data—PHI—be secure. In the United States, the Privacy Rule is in place to assure that PHI is properly protected, while also allowing for the flow of health information needed to provide and promote high-quality health care. The Rule strikes a balance that permits important uses of PHI but at the same time protecting the privacy of people who seek health services, for example at dentist or doctor offices, clinics, or hospitals. Given that the health care marketplace is diverse and in some regions, complex, the Privacy Rule is designed to be flexible and comprehensive to cover the variety of uses and disclosures that need to be addressed. Again, we note that HIPAA, Privacy Rule, and PHI, etc. are all federal, U.S.-based and that states, counties, health care districts, municipalities, and cities are adapting their own, in most cases, stricter rules, laws, and guidelines to protect PHI. As a result, there is an increasing number of regions and states with differing patient data security laws and regulations; the regulatory schemes are growing more complex and stricter. As noted, the rules are constantly shifting and getting more specific. Third-party providers of healthcare and patient management software tools that operate across multiple regions are having a difficult time keeping up and providing systems that are flexible and, also important, can scale, that is, can expand to cover a growing population in a region without degrading performance or violating laws and protocols.

Embodiments of the present invention enable a patient data management system that has a global entry point to what is referred to as a zone-based system servicing multiple regions. The entry point is to a global server that is in communication with multiple zone-based systems servicing multiple regions. As noted, a region may be a city, county, district, state, province, or country, among others. It is worth noting that certain regions may have rules dictating where its residents PHI or PHI-type data (for data outside the U.S. regulatory scheme) resides; that is, where the data is physically stored. Generally, there are dedicated zone computers within the region from where the data originates (country of origin, state of origin, etc.). Each region may have its own zone server. Some regions may have multiple zone servers depending on population, volume of health-related data, and other factors. The zone architecture described below in the figures also greatly facilitates scaling when needed for regions that are growing. Features of the zone architecture also enable customizing or tailoring data security, privacy, and protection.

In the United States, in one embodiment, the default or automatic configuration for data security and protection is the HIPAA standard that calls for “all reasonable precautions,” a broad dictum for securing data, leaving a lot of discretion to operators and providers. However, as noted above and described below, the architecture of the multiple zones and global base and entry point system of the present invention allows for changing data security protection parameters, rules, and configurations. For example, a region may modify or update one of many configurations: HIPAA-compliant data encryption requirements (e.g., adding cipher mode to AES 256-bit encryption); communication protocols (e.g., adding 256-bit SSL connection for transmission or adding TLS 1.2 2048 bit key); deletion rules (the number of days PHI data is stored may change); decryption only for processing; re-encryption for any PHI at rest; data exposure limits; data logging requirements; among many other parameters. Embodiments of the present invention facilitate changing or customizing these parameters and many others only for the zone servers in a specific region without effecting zones in any other region. As such, a zone for a city which has its own security rules for PHI can be customized without affecting zones in the rest of the state that city is in. In a larger scale example, configurations for a country, such as the Netherlands can be over-hauled with no adverse consequences for Saudi Arabia or the United States.

In one embodiment, a patient management software system is provided by a service provider and is integrated with existing patient database software. An existing system for managing patient data operated by, for example, a dentist, doctor or veterinary office typically includes a database storing patient data. The database software can be from one of many third-party vendors and in each case the data is stored or organized a little differently. In some cases, patient data may simply be stored in flat files. In the described embodiment, the software of the present invention essentially replaces existing patient management software but the database software (or flat files) containing the patient data remains.

The software of the present invention functions with existing database software but provides enhanced functionality with respect to managing, communicating, and developing relationships with patients as well as marketing to new ones and conducting surveys. As such, the described embodiment includes existing database software, an office administration client machine (essentially, an office administrator and/or receptionist desktop computer), and service provider servers and databases, geographically dispersed as described below.

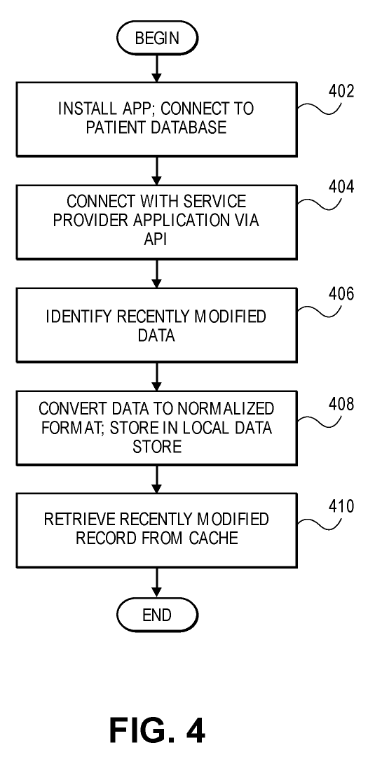

In one embodiment, a dentist office decides to use service provider patient management software to enhance its engagement with patients the patient management software can be used in doctor offices or any office setting where patients or clients need to be managed. Part of this process involves installing service provider software on the dentist office server computer. Once this service provider app is installed on the server, it initially connects with the patient database. One distinguishing feature of the service provider software is that the app is able to connect, communicate, and operate with multiple commercially available database software. The dentist office (“user” or “client”) does not have to convert their patient data to a specific service provider format; they can continue using their third-party vendor database software. Previous patient management software may remain installed or they may remove it. The process going forward from app installation is described in FIG. 4.

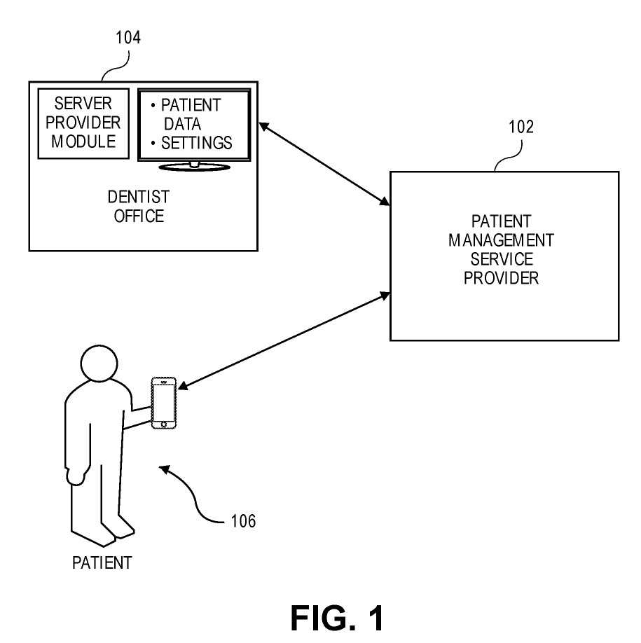

FIG. 1 is a block diagram showing relationships between the primary entities or actors of the present invention. A patient data management software and system provider 102 operates multiple servers, databases, APIs, and other components which provide patient communications and engagement tools, as well as other services, to offices, such as dentist offices in the described embodiment. As noted above, a primary aspect of the invention addresses data security and privacy concerns that arise when implementing a global solution for patient data management software. In alternative embodiments, other types of offices, such as medical offices or veterinary offices, may also be users of the present invention. The service provider system is in communication via the Internet or other suitable network with a dentist office 104. Office 104 has a software module or app provided by the service provider that executes on the office's servers and in communication with its patient database. There are also settings as determined by the user that pertain to the patient management software as supplied by provider 102. A patient 106 receives communications, such as appointment confirmations, reminders, cancellations, and the like, relating to the relationship between patient 106 and dentist office 104 from service provider 102. Patient 106 can also have communications directly with office 104. Patient 106 receives communications via a connected device, in most cases a smartphone, and may send communications back to service provider 102 servers. As described in detail below, the inventive concepts in the arrangement shown in FIG. 1 are embodied in service provider 102 supplying tools and services to dentist office 104 for patient engagement which results in communications with patient 106 that benefit office 104 and patient 106.

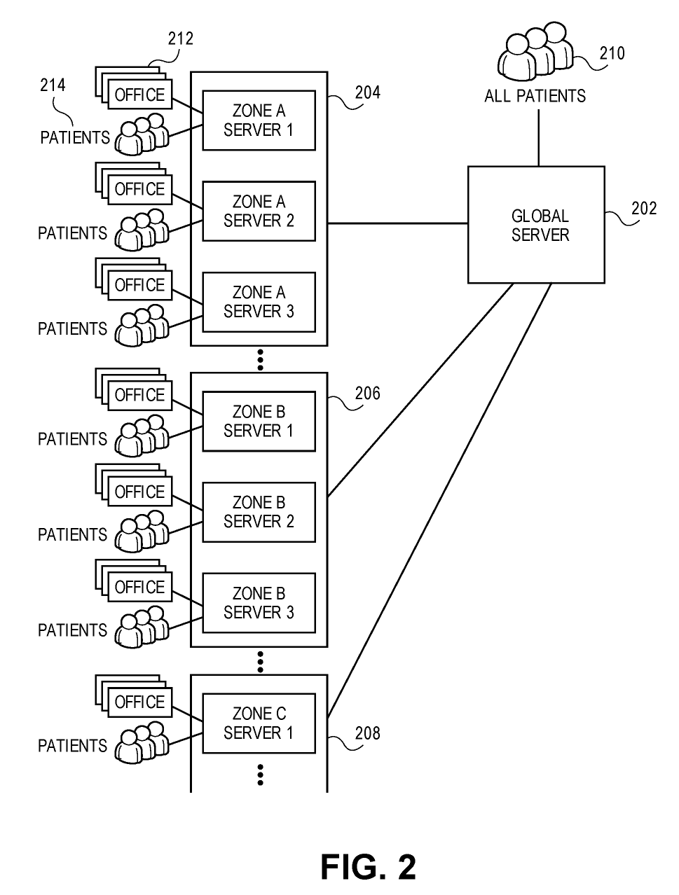

FIG. 2 is a block diagram showing components of service provider 102 in accordance with one embodiment. Service provider 102 operates via sites in different regions where there may be various laws, regulations, and guidelines with respect to protecting patient data and patient privacy. From a legal perspective, it is important for the service provider to operate within these parameters in each of the regions where its software is being used to engage with patients. A global server 202 operates across all regions and performs functions on patient data that are not restricted by local or region-specific patient data privacy protections. Another component of service provider 102 is zone servers. Shown are zones 204, 206, and 208. Each zone may correspond to a region which, as noted above, may be of varying geographic size (country, province, state etc.), have a certain number of offices within each, and have its own patient data privacy regulations/laws. Criteria for creating a zone are described below. Each zone has one or more servers for handling operations for offices or clients 212. The service provider determines when to add zone servers in a particular zone. Each zone server may also be in communication with multiple offices 212. In FIG. 2, and for ease of illustration, patients 214 represent all patients for all offices 212 being serviced by a single zone server, such as server 1 for zone A. Likewise, zone B, server 2, for example, services multiple offices and patients in another zone, such as the western region of the United States or another country, such as Luxemburg. Some countries or states may have one or more zones. It is important to note here that there is a large, complex, technical infrastructure required for implementing the zone network topology and communication described in FIG. 2 and throughout this disclosure. Global server 202 may also be in direct communication with all patients 210 across all zones. It is important to note that these communications do not violate zone-specific patient data privacy laws and regulations.

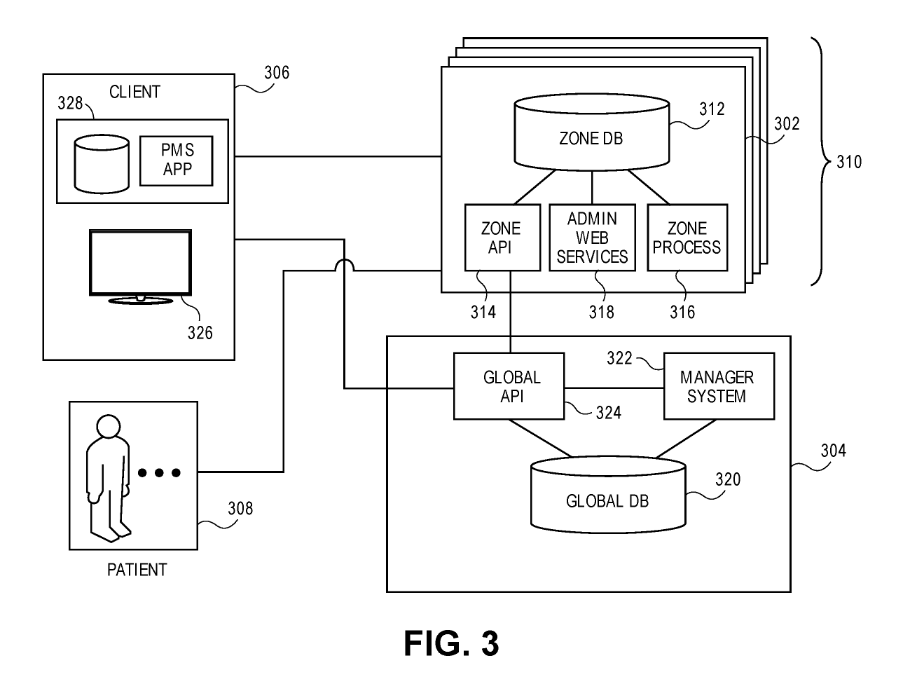

FIG. 3 is a block diagram showing the primary entities and connections among components and modules within these entities in accordance with one embodiment. Shown are the three main entities: user or client 306, patient 308, and service provider represented by components 302 and 304. Service provider 302 represents one zone, as described in FIG. 2, and boxes 310 illustrate that there are multiple zones being serviced by one global system manager 304. A zone 302 has a zone database 312 that stores data for all offices in that zone. Also shown are zone API 314, zone process 316, and administration web services 318, all exchanging or retrieving data from database 312. Each zone 302 and 310 is in communication with a global management system 304. This system 304, of which there is one, has three primary components: global API 324, manager system 322, and global database 320, all of which are in communication with each other. Global API 324 is in communication with all offices across all zones, as shown by connection with office 306. Global API 324 is in communication with all zone APIs 314. Office 306 has a client-side patient management software app (provided by the service provider) that has a local data store. The app and all patient management services can be shown on monitor 326 at the office. A patient 308 is in communication with zone 302 and, in one embodiment, does not communicate directly with global management system 304.

FIG. 4 is flow diagram of a process of installing and utilizing patient management software in accordance with one embodiment. At step 402 a patient management app (provided by the service provider) is installed on the office server computer. This module is referred to herein as a “client-side app.” As noted, the first operation performed by the app is connecting to the office patient database. The app first identifies which third party database software is being used (the database vendor) and establishes a connection to read the data using a suitable data interface. The interface processing code base has deep integration with database data. This deep integration also allows for data analytics in a Web administration node, such as enterprise usage across all different database vendors. In another embodiment, the service provider is informed beforehand what type of database is being used and installs the appropriate app for that database.

At step 404 the patient management app connects to a service provider API operated on a service provider server. An API endpoint is invoked and the app connects to an application on the service provider server. The patient management client-side app and the application on the service provider computer can now exchange data. At step 406 the client-side app examines the patient data and identifies all data that was recently modified. The parameters for “recently modified” can be set by the service provider in consultation with the office. For example, recently modified data may be of two types: business critical, such as appointment changes, cancellations, and events that may immediately affect the office's schedule, and less critical data, such as address or name changes that do not occur very frequently. The first type of modified data is synchronized on a minute-by-minute basis. The second type of data is synchronized every few hours, such as every six hours in one embodiment. In some cases, there may be not be a history-tracking data or a tracking tool in the office or patient database that is relevant to the scope of the data examined in the various embodiments of the present invention. To address this issue, in one embodiment, there is an additional logic layer to the patient management app on the office server provided by the service provider.

This layer is able to generate modification timestamps on recently modified data. As such, this layer is used to identify recently modified data in the office patient database. There is also an application layer data storage that is separate from the office database that is used to store the recently modified data after it is converted to the service provider format. The data is then sent to the API. How recently modified data is identified is dictated in large part by the database vendor and how the client-side app is able to understand how the vendor identifies the data and extracts it. Modified data for a patient can be, for examples, updates to contact information (email, phone number, address), a new appointment, a cancellation, appointment change, new patient, or a change in contact method.

Once the app has identified the modified data, at step 408 the data is converted (by the service provider) to a normalized format defined by the service provider so that it can be processed by the API. We note that the patient data in the patient management database (office database) is not converted. The converted data in the form of records is stored in a local data store under control of the patient management app on the dentist office server.

At step 410 a single patient data record is retrieved from the local data store or cache. This record represents a patient record that was recently modified. The patient management application then checks to see if this record already exists in the local cache. If it does, the patient management application does nothing; the selected record is dropped and not added to the local cache since it is already stored there. More specifically, as described below, no sub-worker process is started. If the record does not exist in the cache, the API detects the difference, and the record is added. Once the modified records are in the cache at the API endpoint the data processing phase begins.

The API has a sub-worker process component (in addition to the endpoint component described above). Here, the API detects a change to the data and stores differences in the data (modified data) to be passed to the sub-worker process. A sub-worker process picks up processes from the process queue and works through the queue. It compares data to determine the differences in the data. It waits for a record to be added to the cache. Once this is done, a large body of logic and rules is applied to the modified data to see how best to communicate with the patient or with the office.

In the described embodiment, the system, more specifically the queue, is updated frequently, for example, every minute. To illustrate, a patient may cancel an appointment, change reminder frequency or cancel reminders, re-schedule, make new appointments (bookings) for cancelled appointments, and so on. In all cases, sub-worker processes detect and pick up the change. As described below, there are many possible options and settings that can be performed on a patient record. In one embodiment, a message or communication may be sent to the patient and to the dentist office. If there is a message or communication, it is queued up by a zone process server.

Another component under control of the service provider is referred to as a global API server. This server is able to process data across various countries or regions; there may be several zone APIs within the one country. In one embodiment, the global API server keeps track of how the application is performing. Any operational problems, re-synchronizations, and the like, are handled on the global API server. A system manager may be used by the administrator web app to look at patient data. The web application is technically maintained through the system manager. There may also be safeguards in place. The global API server can be pinged by the application, for example every minute, or at an interval set by the service provider. In one embodiment, the zone API server and global API server are connected. In other embodiments, the two components are not connected or able to communicate directly with each other.

Another role of the global API is to handle data not under the purview of privacy laws/regulations, referred to as non-PHI data, that is, data that is not protected by the privacy health initiative or HIPAA. Non-PHI data processed by the global API may be done without having to communicate with the application on the corresponding zone API. For example, it is pinged by the client-side application directly when a synchronization is performed. The global API can send a message to the zone API to do calculations after a synchronization. Because of data privacy restrictions set in place by HIPA, interactions with the global API server do not include any patient data from zones or client-side apps. This allows the global API to synchronize all the data.

A global manager system, connected to the global API may be used by the service provider to check performance aspects of the overall patient data management system. It can also be used to add new offices or practices to specific zones, as well as performing other functions. Service provider login, office logins (although final authorization for logins occur in the specific zone), and other events are handled by the global API. Technical events in the patient data management system can be logged or recorded at the global level using the global API. For example, an event may be that all sub-worker processes in a zone API are busy, that there has been a disconnection, that an authorized protocol has failed, or that the system is getting close to a threshold.

As described throughout, the zone API and zone process servers are components under control of the service provider. Patient records are stored in zone-specific databases only. Settings for each office are stored in a zone database. The database is also connected to an office administration software module which contains office settings, including office and patient permissions. Zone processes can also be used to send “one-off” messages to offices and to send things such as patient surveys, reminders, recalls, and the like. The zone API database is connected to the administration software module interface. A full synchronization process can be executed to do a re-synchronization of all the data, for example, when a new office becomes a client or when the service provider or client wants to check all the data, by-passing the modified data only checking described above, basically requiring a re-synchronization of the data. In the global manager administration system, a service provider employee initiates a full synchronization, sending a signal to the client application on the office server to start a full synchronization, thereby instructing the zone API to start the process for the office.

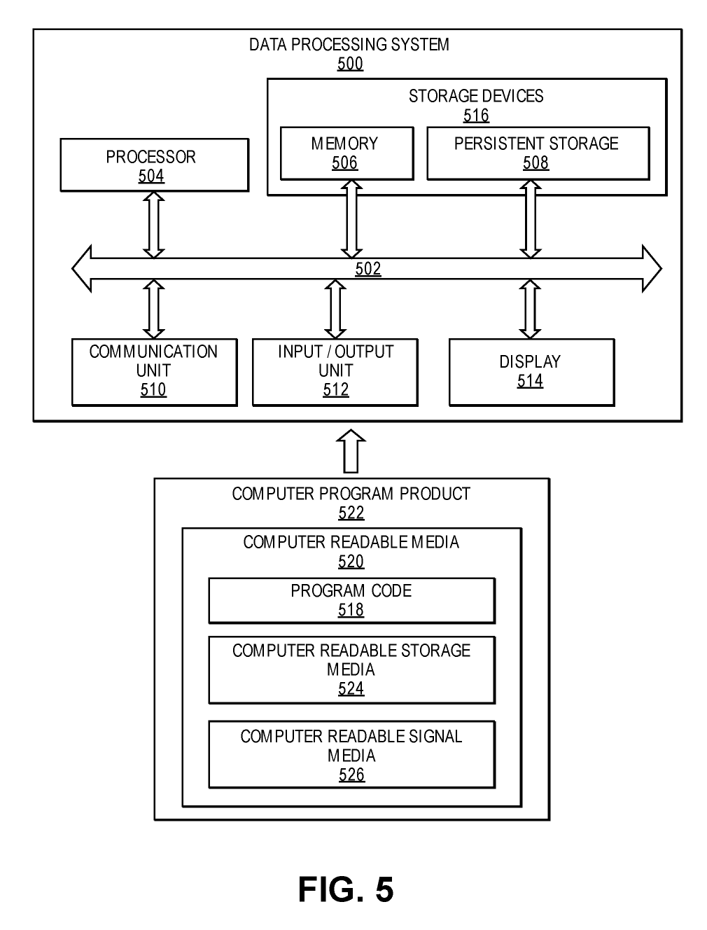

FIG. 5 is an illustration of a data processing system 500 is depicted in accordance with some embodiments. Data processing system 500 may be used to implement one or more computers used in a controller or other components of various systems described above. In some embodiments, data processing system 500 includes communications framework 502, which provides communications between processor unit 504, memory 506, persistent storage 508, communications unit 510, input/output (I/O) unit 512, and display 514. In this example, communications framework 502 may take the form of a bus system.

Processor unit 504 serves to execute instructions for software that may be loaded into memory 506. Processor unit 504 may be a number of processors, a multi-processor core, or some other type of processor, depending on the particular implementation.

Memory 506 and persistent storage 508 are examples of storage devices 516. A storage device is any piece of hardware that is capable of storing information, such as, for example, without limitation, data, program code in functional form, and/or other suitable information either on a temporary basis and/or a permanent basis. Storage devices 516 may also be referred to as computer readable storage devices in these illustrative examples. Memory 506, in these examples, may be, for example, a random access memory or any other suitable volatile or non-volatile storage device. Persistent storage 508 may take various forms, depending on the particular implementation. For example, persistent storage 508 may contain one or more components or devices. For example, persistent storage 508 may be a hard drive, a flash memory, a rewritable optical disk, a rewritable magnetic tape, or some combination of the above. The media used by persistent storage 508 also may be removable. For example, a removable hard drive may be used for persistent storage 508.

Communications unit 510, in these illustrative examples, provides for communications with other data processing systems or devices. In these illustrative examples, communications unit 510 is a network interface card.

Input/output unit 512 allows for input and output of data with other devices that may be connected to data processing system 500. For example, input/output unit 512 may provide a connection for user input through a keyboard, a mouse, and/or some other suitable input device. Further, input/output unit 512 may send output to a printer. Display 514 provides a mechanism to display information to a user.

Instructions for the operating system, applications, and/or programs may be located in storage devices 516, which are in communication with processor unit 504 through communications framework 502. The processes of the different embodiments may be performed by processor unit 504 using computer-implemented instructions, which may be located in a memory, such as memory 506.

These instructions are referred to as program code, computer usable program code, or computer readable program code that may be read and executed by a processor in processor unit 504. The program code in the different embodiments may be embodied on different physical or computer readable storage media, such as memory 506 or persistent storage 508.

Program code 518 is located in a functional form on computer readable media 520 that is selectively removable and may be loaded onto or transmitted to data processing system 500 for execution by processor unit 504. Program code 518 and computer readable media 520 form computer program product 522 in these illustrative examples. In one example, computer readable media 520 may be computer readable storage media 524 or computer readable signal media 526.

In these illustrative examples, computer readable storage media 524 is a physical or tangible storage device used to store program code 518 rather than a medium that propagates or transmits program code 518.

Alternatively, program code 518 may be transmitted to data processing system 500 using computer readable signal media 526. Computer readable signal media 526 may be, for example, a propagated data signal containing program code 518. For example, computer readable signal media 526 may be an electromagnetic signal, an optical signal, and/or any other suitable type of signal. These signals may be transmitted over communications channels, such as wireless communications channels, optical fiber cable, coaxial cable, a wire, and/or any other suitable type of communications channel.

The different components illustrated for data processing system 500 are not meant to provide architectural limitations to the manner in which different embodiments may be implemented. The different illustrative embodiments may be implemented in a data processing system including components in addition to and/or in place of those illustrated for data processing system 500. The different embodiments may be implemented using any hardware device or system capable of running program code 518.

Therefore, it is to be understood that the present disclosure is not to be limited to the specific examples illustrated and that modifications and other examples are intended to be included within the scope of the appended claims. Moreover, although the foregoing description and the associated drawings describe examples of the present disclosure in the context of certain illustrative combinations of elements and/or functions, it should be appreciated that different combinations of elements and/or functions may be provided by alternative implementations without departing from the scope of the appended claims. Accordingly, parenthetical reference numerals in the appended claims are presented for illustrative purposes only and are not intended to limit the scope of the claimed subject matter to the specific examples provided in the present disclosure.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

What is claimed is:

1. A method of managing patient data, the method comprising:
connecting with a client database to access client data stored on a client server in a first zone in a geographic region;
examining the client data to identify recently modified data, wherein the the recently modified client data is converted from a pre-existing format to a service-provider format;
storing the converted recently modified data in a service-provider application storage are in the first zone;
applying a data privacy rule set to the client data wherein said rule set is specific to the geographic region; and
applying the rule set to the recently modified data in the service-provider format.

2. A method as recited in claim 1 further comprising:
customizing data security parameters for a specific zone without affecting another zone.

3. A method as recited in claim 1 wherein client data originates from a zone server in the specific region.

4. A method as recited in claim 1 further comprising:
connecting to a service-provider application programming interface (“API”), wherein the service-provider API has a sub-worker process component, said process component receiving recently modified data.

5. A method as recited in claim 4 wherein the sub-worker process component receives processes from a process queue.

6. A method as recited in claim 1 wherein a zone API server and the global API server are connected.

7. A method as recited in claim 6 wherein non-regulated patient data is processed by the global API and wherein said processing is done without communicating with the service-provider application or patient data from zone servers.

8. A method as recited in claim 1 wherein the global API server synchronizes all patient data.

9. A method as recited in claim 1 wherein detecting that a patient record does not exist in the service-provider application storage further comprises synchronizing the recently modified data.

10. A method as recited in claim 1 further comprising:
installing a service-provider application on a client computer wherein the application operates with client data in the pre-existing format stored in a client database.

11. A method as recited in claim 10 wherein non-modified data in the client database is not converted to the service-provider format.

12. A method as recited in claim 1 further comprising:
determining a mode of communication with a patient.

13. A patient data management system for managing patient data and applying patient data privacy rules comprising:
a client-side application operating on a client server, the application having an API and local storage area;
one or more zone servers, a zone server having a zone database, a zone API, an administration web services module, and a zone process, wherein the zone API, web services module, and zone process exchange and retrieve patient data through the zone database;
a global manager server having a global API, a manager system, and a global database; and
a first subset of the zone servers servicing a first region and having a first set of patient data privacy rules and a second subset of servers servicing a second region and having a second set of patient data privacy rules specific to the second region, the first subset and second subset being serviced by a global manager server.

14. A system as recited in claim 13 wherein the zone API is in communication with the global API.

15. A system as recited in claim 13 wherein the client-side application is in communication with the zone API and the global API.

16. A system as recited in claim 13 wherein the global manager server performs functions on patient data that are not restricted by the first set of patient data privacy rules or the second set of patient data privacy rules.

17. A system as recited in claim 13 wherein the global management server is in direct communication with a plurality of patients.

18. A system as recited in claim 13 wherein patient data transactions in a zone server is in accordance with zone-specific data privacy laws.

19. A system as recited in claim 18 wherein multiple sub-worker processes are in a queue in the zone server, a sub-worker process handling messages and communications to a plurality of patients.

20. A system as recited in claim 13 wherein the global management server examines overall performance multiple client-side applications and multiple servers.
